(19) United States
(12) Patent Application Publication
(10) Pub. No.: US 2008/0114962 A1
(43) Pub. Date: May 15, 2008

(54) Silent memory reclamation

(76) Inventor: John M. Holt, Essex (GB)

Correspondence Address: PERKINS COIE LLP, P.O. BOX 2168, MENLO PARK, CA, 94026, US

(21) Appl. No.: 11/973,349

(22) Filed: Oct. 5, 2007

Related U.S. Application Data
(60) Provisional application No. 60/850,500, filed on Oct. 9, 2006.
(60) Provisional application No. 60/850,537, filed on Oct. 9, 2006.

(30) Foreign Application Priority Data
Oct. 5, 2006 (AU) 2006 905 525
Oct. 5, 2006 (AU) 2006 905 534

(51) Int. Cl. G06F 12/00

(52) U.S. Cl. 711/170; 711/147

(57) ABSTRACT

A method and system for reclaiming memory space occupied by replicated memory of a multiple computer system utilizing a replicated shared memory (RSM) system or a hybrid or partial RSM system is disclosed. The memory is reclaimed on those computers not using the memory even though one (or more) other computers may still be referring to their local replica of that memory. Instead of utilizing a general background memory clean-up routine, a specific memory deletion action (177A) is provided. Thus memory deletion, or clean up, instead of being carried out at a deferred time, but still in the background as in the prior art, is not deferred and is carried out in the foreground under specific program control.

### CROSS-REFERENCE TO RELATED APPLICATIONS

The present application claims the benefit of priority to U.S. Provisional Application Nos. 60/850,500 (5027BJ-US) and 60/850,537 (5027Y-US), both filed 9 Oct. 2006; and to Australian Provisional Application Nos. 2006 905 525 (5027BK-AU) and 2006 905 534 (5027Y-AU), both filed on 5 Oct. 2006, each of which are hereby incorporated herein by reference.

This application is related to concurrently filed U.S. Application entitled “Silent Memory Reclamation,” (Attorney Docket No. 61130-8029.US02 (5027BJ-US02)) and concurrently filed U.S. Application entitled “Silent Memory Reclamation,” (Attorney Docket No. 61130-8029.US03 (5027BJ-US03)), each of which are hereby incorporated herein by reference.

### FIELD OF THE INVENTION

The present invention relates to computing. The present invention finds particular application to the simultaneous operation of a plurality of computers interconnected via a communications network.

### BACKGROUND

International Patent Application No. PCT/AU2005/000581 (Attorney Ref 5027D-WO) published under WO 2005/103927 (to which U.S. patent application Ser. No. 11/111,778 and published under No. 2006-0095483 corresponds) in the name of the present applicant, discloses how different portions of an application program written to execute on only a single computer can be operated substantially simultaneously on a corresponding different one of a plurality of computers. That simultaneous operation has not been commercially used as of the priority date of the present application. International Patent Application Nos. PCT/AU2005/001641 (WO2006/110937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds and PCT/AU2006/000532 (WO2006/110 957) (Attorney Ref: 5027F-D2-WO) in the name of the present applicant also disclose further details. The contents of the specification of each of the abovementioned prior application(s) are hereby incorporated into the present specification by cross reference for all purposes.

The abovementioned WO 2005/103 927 discloses delayed finalization whereby finalization or reclamation and deletion of memory across a plurality of machines was delayed or otherwise aborted until all computers no longer used the replicated memory location or object that is to be deleted.

### GENESIS OF THE INVENTION

The genesis of the present invention is a desire to provide a more efficient means of memory deletion or reclamation or finalisation over the plurality of machines than the abovementioned prior art accomplished.

### SUMMARY OF THE INVENTION

According to a first aspect of the present invention there is disclosed a method of running simultaneously on a plurality of computers at least one application program each written to operate only on a single computer, said computers being interconnected by means of a communications network and each with an independent local memory, and where at least one application memory location is replicated in each of said independent local memories and updated to remain substantially similar, said method comprising the steps of:

(i) executing different portions of said application program(s) on different ones of said computers and for at least some of the said computers creating a like plurality of substantially identical objects each in the corresponding computer and each having a substantially identical name, and

(ii) permitting each computer to delete its currently unused local memory corresponding to a replicated object and without initializing or execution an associated application clean-up routine, notwithstanding that other one(s) of said computers are currently using their corresponding local memory.

According to a second aspect of the present invention there is a multiple computer system having at least one application program each written to operate only on a single computer but running simultaneously on a plurality of computers interconnected by a communications network, wherein each of said computer contains an independent local memory, and where at least one application program memory location is replicated in each of said independent local memories and updated to remain substantially similar, and wherein different portions of said application program(s) execute substantially simultaneously on different ones of said computers and for at least some of the said computers a like plurality of substantially identical objects are replicated, each in the corresponding computer, and wherein each computer can delete its currently local unused memory corresponding to a replicated application object and without initializing or executing an associated application clean-up routine, notwithstanding that other one(s) of said computers are currently using their corresponding local memory.

In accordance with the third aspect of the present invention there is disclosed a single computer adapted to form part of a multiple computer system, said single computer having an independent local memory and a data port by means of which the single computer can communicate with a communications network of said multiple computer system to send and receive data to update at least one application memory location which is located in said independent local memory and replicated in the independent local memory of at least one other computer of said multiple computer system to enable different portions of the same application program to execute substantially simultaneously on different computers of said multiple computer system, and wherein said single computer can delete its local currently unused memory corresponding to a replicated application location and without initializing or executing an associated application clean-up routine, notwithstanding that other one(s) of said computers are currently using their corresponding local memory.

In accordance with a fourth aspect of the present invention there is disclosed a computer program product which when loaded into a computer enables the computer to carry out the above method.

### BRIEF DESCRIPTION OF THE DRAWINGS

A preferred embodiment of the invention will now be described, by way of example only, with reference to the accompanying drawings in which:

FIG. 1 corresponds to FIG. 15 of WO 2005/103927,

FIG. 1A is a schematic representation of an RSM multiple computer system,

FIG. 1B is a similar schematic representation of a partial or hybrid RSM multiple computer system

FIG. 2 corresponds to FIG. 16 of WO 2005/103927,

FIG. 3 corresponds to FIG. 17 of WO 2005/103927,

FIG. 4 corresponds to FIG. 18 of WO 2005/103927,

FIG. 5 corresponds to FIG. 19 of WO 2005/103927, and

FIG. 6 is a modified version of FIG. 3 outlining the preferred embodiment.

### DETAILED DESCRIPTION

Broadly, the preferred embodiment of the present invention relates to a means of extending the delayed finalisation system of the abovementioned prior art to perform spontaneous memory reclamation by a given node (or computer) silently, such that the memory may be reclaimed on those nodes or computers that no longer need to use or require the replicated object in question without causing application finalization routines or the like to be executed or performed. Thus each node or computer can reclaim the local memory occupied by replica application memory objects (or more generally replica application memory locations, contents, assets, resources, etc) without waiting for all other machines or computers on which corresponding replica application memory objects reside to similarly no longer use or require or refer-to their corresponding replica application memory objects in question. A disadvantage of the prior art is that it is not the most efficient means to implement memory management. The reason for this is that the prior art requires all machines or computers to individually determine that they are ready and willing to delete or reclaim the local application memory occupied by the replica application memory object(s) replicated on one or more machines. This does not represent the most efficient memory management system as there is a tendency for substantial pools of replicated application memory to be replicated across the plurality of machines but idle or unused or unutilized, caused by a single machine continuing to use or utilise or refer-to that replicated memory object (or more generally any replicated application memory location, content, value, etc).

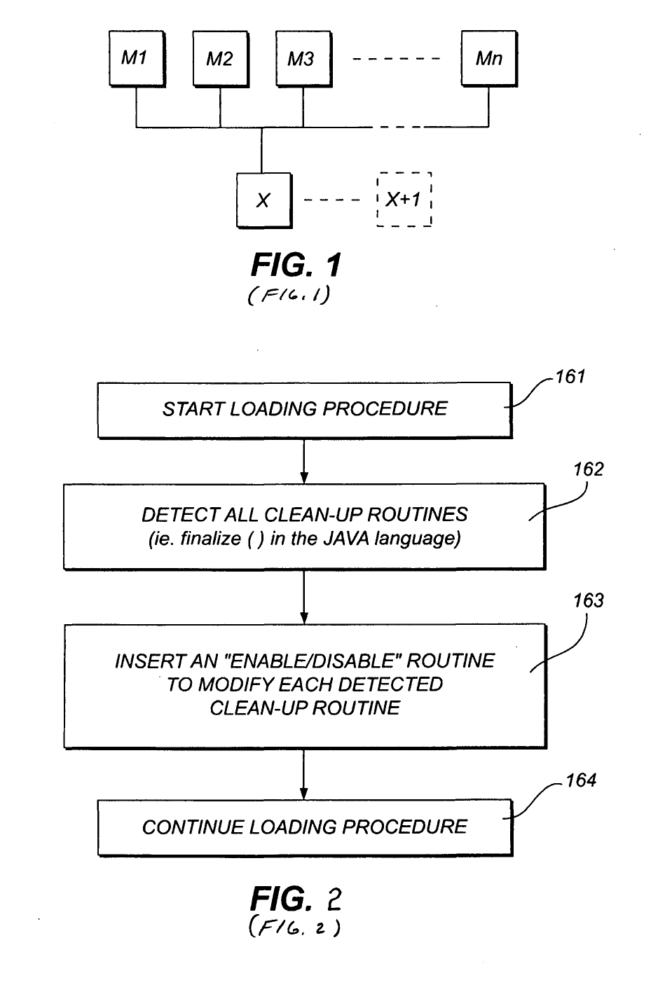

Consequently, even though all machines M1-Mn of FIG. 1, minus one, may have determined they are willing and ready to delete their replica application memory locations/contents replicated on the plurality of machines, such as a replica application memory location/content called Z, they will be unable to do so because of the continued use of that replicated application memory location/content by another machine such as machine M1. If machine M1 continues to use or utilise or refer-to its replica application memory location/content Z for a long period of time, then the local application memory space/capacity consumed by the corresponding replica application memory locations/contents Z on the others of the plurality of machines, will sit idle and be unable to be used for useful work by those other machines M2, M3 . . . Mn.

In a replicated shared memory system, or a partial or hybrid RSM system where hundreds, or thousands, or tens of thousands of replicated application memory locations/contents may be replicated across the plurality of machines, were these corresponding replica application memory locations/contents to remain undeleted on the plurality of machines whilst one machine (or some other subset of all machines on which corresponding replica application memory locations/contents reside) continues to use the replica application memory locations/contents, then such a replicated memory arrangement would represent a very inefficient use of the local application memory space/capacity of the plurality of machines (and specifically, the local application memory space/capacity of the one or more machines on which corresponding replica application memory locations/contents reside but are unused or unutilized or un-referenced). Therefore, it is desired to address this inefficiency in the prior art replica application memory deletion and reclamation system by conceiving of a means whereby those machines of the plurality of machines that no longer need to use or utilise or refer-to a replicated application memory location/content (or object, asset, resource, value, etc) are free to delete their local corresponding replica application memory location/content without causing the remaining replica application memory locations/contents on other machines to be rendered inoperable, inconsistent, or otherwise non-operable. Thus preferably the deletion takes place in silent fashion, that is, it does not interfere with the continued use of the corresponding replica application memory locations/contents on the one or ones of the plurality of machines that continue to use or refer-to the same corresponding replicated application memory location/content (or object, value, asset, array, etc).

To assist the reader, FIGS. 1 and 2-5 of the present specification repeat FIGS. 15-19 of the abovementioned WO 2005/103 927. A brief explanation of each drawing is provided below, but the reader is additionally directed to the abovementioned specifications for a more complete description of FIGS. 1 and 2-5.

FIG. 1 shows a multiple computer system arrangement of multiple machines M1, M2, . . . , Mn operating as a replicated shared memory arrangement, and each operating the same application code on all machines simultaneously or concurrently. Additionally indicated is a server machine X which is conveniently able to supply housekeeping functions, for example, and especially the clean up of structures, assets and resources. Such a server machine X can be a low value commodity computer such as a PC since its computational load is low. As indicated by broken lines in FIG. 15, two server machines X and X+1 can be provided for redundancy purposes to increase the overall reliability of the system. Where two such server machines X and X+1 are provided, they are preferably operated as redundant machines in a failover arrangement.

It is not necessary to provide a server machine X as its computational operations and load can be distributed over machines M1, M2, . . . , Mn. Alternatively, a database operated by one machine (in a master/slave type operation) can be used for the housekeeping function(s).

FIG. 1A is a schematic diagram of a replicated shared memory system. In FIG. 1A three machines are shown, of a total of “n” machines (n being an integer greater than one) that is machines M1, M2, . . . Mn. Additionally, a communications network 53 is shown interconnecting the three machines and a preferable (but optional) server machine X which can also be provided and which is indicated by broken lines. In each of the individual machines, there exists a memory 102 and a CPU 103. In each memory 102 there exists three memory locations, a memory location A, a memory location B, and a memory location C. Each of these three memory locations is replicated in a memory 102 of each machine.

This arrangement of the replicated shared memory system allows a single application program written for, and intended to be run on, a single machine, to be substantially simultaneously executed on a plurality of machines, each with independent local memories, accessible only by the corresponding portion of the application program executing on that machine, and interconnected via the network 53. In International Patent Application No PCT/AU2005/001641 (WO2006/110,937) (Attorney Ref 5027F-D1-WO) to which U.S. patent application Ser. No. 11/259,885 entitled: “Computer Architecture Method of Operation for Multi-Computer Distributed Processing and Co-ordinated Memory and Asset Handling” corresponds, a technique is disclosed to detect modifications or manipulations made to a replicated memory location, such as a write to a replicated memory location A by machine M1 and correspondingly propagate this changed value written by machine M1 to the other machines M2 . . . Mn which each have a local replica of memory location A. This result is achieved by the preferred embodiment of detecting write instructions in the executable object code of the application to be run that write to a replicated memory location, such as memory location A, and modifying the executable object code of the application program, at the point corresponding to each such detected write operation, such that new instructions are inserted to additionally record, mark, tag, or by some such other recording means indicate that the value of the written memory location has changed.

An alternative arrangement is that illustrated in FIG. 1B and termed partial or hybrid replicated shared memory (RSM). Here memory location A is replicated on computers or machines M1 and M2, memory location B is replicated on machines M1 and Mn, and memory location C is replicated on machines M1, M2 and Mn. However, the memory locations D and E are present only on machine M1, the memory locations F and G are present only on machine M2, and the memory locations Y and Z are present only on machine Mn. Such an arrangement is disclosed in Australian Patent Application No. 2005 905 582 Attorney Ref 5027I(to which U.S. patent application Ser. No. 11/583,958 (60/730,543) and PCT/AU2006/001447 (WO2007/041762) correspond). In such a partial or hybrid RSM systems changes made by one computer to memory locations which are not replicated on any other computer do not need to be updated at all. Furthermore, a change made by any one computer to a memory location which is only replicated on some computers of the multiple computer system need only be propagated or updated to those some computers (and not to all other computers).

Consequently, for both RSM and partial RSM, a background thread task or process is able to, at a later stage, propagate the changed value to the other machines which also replicate the written to memory location, such that subject to an update and propagation delay, the memory contents of the written to memory location on all of the machines on which a replica exists, are substantially identical. Various other alternative embodiments are also disclosed in the abovementioned specification.

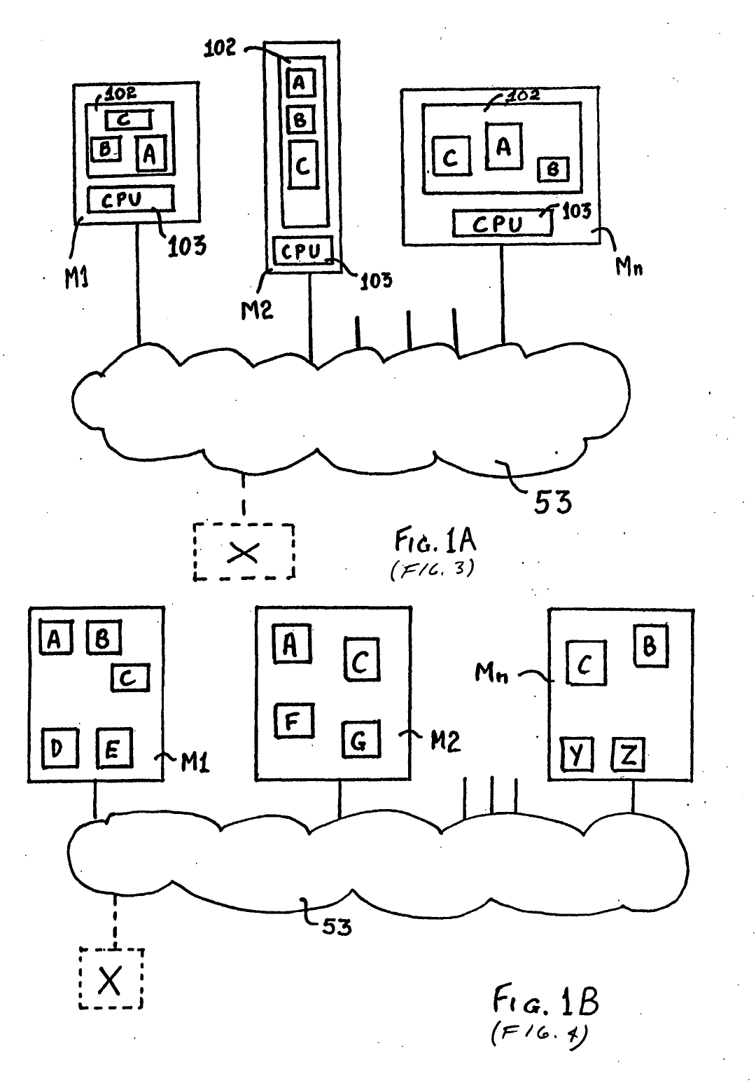

FIG. 2 shows a preferred general modification procedure of an application program to be loaded, to be followed. After loading 161 has been commenced, the instructions to be executed are considered in sequence and all clean up routines are detected as indicated in step 162. In the JAVA language these are the finalization routines or finalize method (e.g., “finalize( )”). Other languages use different terms, and all such alternatives are to be included within the scope of the present invention.

Where a clean up routine is detected, it is modified at step 163 in order to perform consistent, coordinated, and coherent application clean up or application finalization routines or operations of replicated application memory locations/contents across and between the plurality of machines M1, M2 . . . Mn, typically by inserting further instructions into the application clean up routine to, for example, determine if the replicated application memory object (or class or location or content or asset etc)) corresponding to this application finalization routine is marked as finalizable (or otherwise unused, unutilized, or un-referenced) across all corresponding replica application memory objects on all other machines, and if so performing application finalization by resuming the execution of the application finalization routine, or if not then aborting the execution of the application finalization routine, or postponing or pausing the execution of the application finalization routine until such a time as all other machines have marked their corresponding replica application memory objects as finalizable (or unused, unutilized, or unreferenced). Alternatively, the modifying instructions could be inserted prior to the application finalization routine (or like application memory cleanup routine or operation). Once the modification has been completed the loading procedure continues by loading modified application code in place of the unmodified application code, as indicated in step 164. Altogether, the application finalization routine is to be executed only once, and preferably by only one machine, on behalf of all corresponding replica application memory objects of machines M1 . . . Mn according to the determination by all machines M1 . . . Mn that their corresponding replica application memory objects are finalizable.

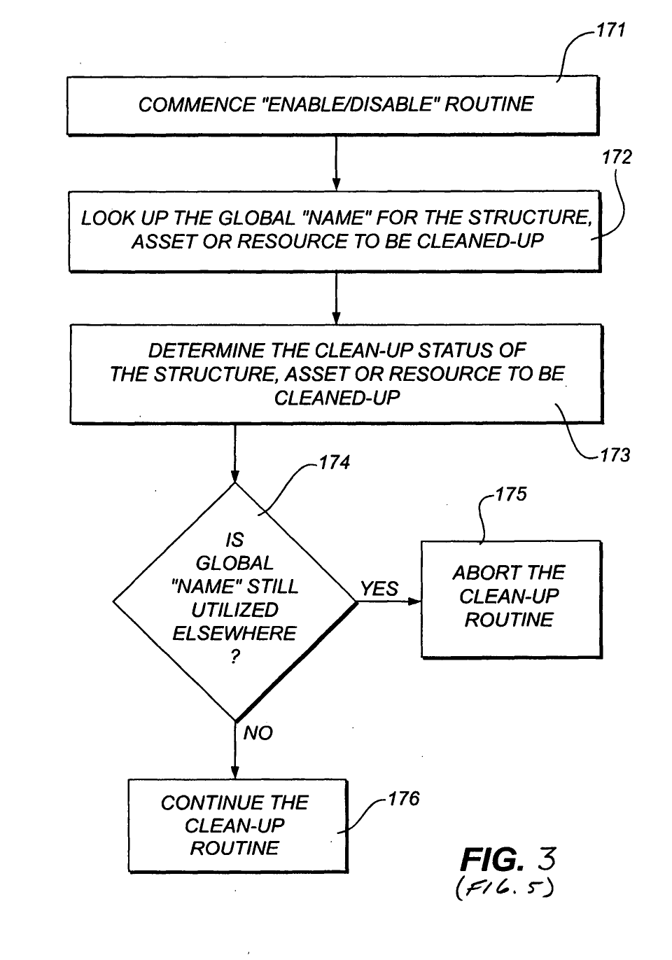

FIG. 3 illustrates a particular form of modified operation of an application finalization routine (or the like application memory cleanup routine or operation). Firstly, step 172 is a preferable step and may be omitted in alternative embodiments. At step 172 a global name or other global identity is determined or looked up for the replica application memory object to which step 171 corresponds. Next at steps 173 and 174, a determination is made whether or not the corresponding replica application memory objects of all the other machines are unused, unutilized, or unreferenced. If the at least one other machine on which a corresponding replica application memory object resides is continuing to use, utilise, or refer-to their corresponding replica application memory object, then this means that the proposed application clean up or application finalization routine corresponding to the replicated application memory object (or location, or content, or value, or class or other asset) should be aborted, stopped, suspend, paused, postponed, or cancelled prior to its initiation. Alternatively, if such application clean-up or application finalization routine or operation has already been initiated or commenced, then continued or further or ongoing execution is to be aborted, stopped, suspended, paused, postponed, cancelled, or the like, since the object or class is still required by one or more of the machines M1, M2 . . . Mn, as indicated by step 175.

However or alternatively, if all corresponding replica application memory objects of each machine M1 . . . Mn is unused, unutilized, or unreferenced, this means that no other machine requires the replicated application memory object (or location, or content, or value or class or other asset). As a consequence the application clean up routine and operation, indicated in step 176, can be, and should be, carried out, and the local application memory space/capacity occupied in each machine by such corresponding replica application memory objects be freed, reclaimed, deleted, or otherwise made available for other data or storage needs.

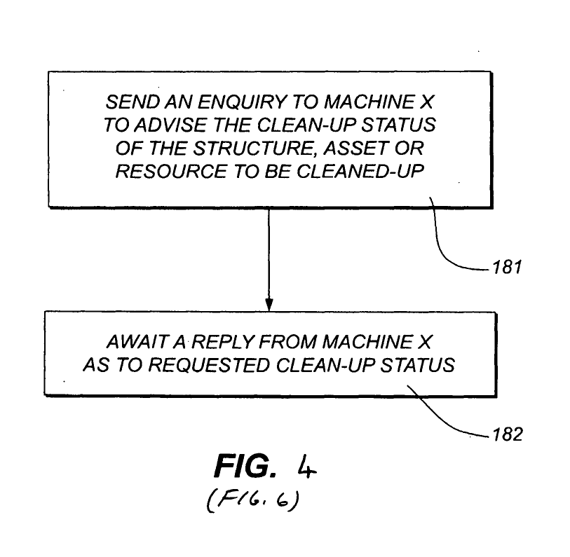

FIG. 4 shows the enquiry made by the machine proposing to execute a clean up routine (one of M1, M2 . . . Mn) to the server machine X. The operation of this proposing machine is temporarily interrupted, as shown in step 181 and 182, and corresponding to step 173 of FIG. 3. In step 181 the proposing machine sends an enquiry message to machine X to request the clean-up or finalization status (that is, the status of whether or not corresponding replica application memory objects are utilised, used, or referenced by one or more other machines) of the replicated application memory object (or location, or content, or value, or class or other asset) to be cleaned-up. Next, the proposing machine awaits a reply from machine X corresponding to the enquiry message sent by the proposing machine at step 181, indicated by step 182.

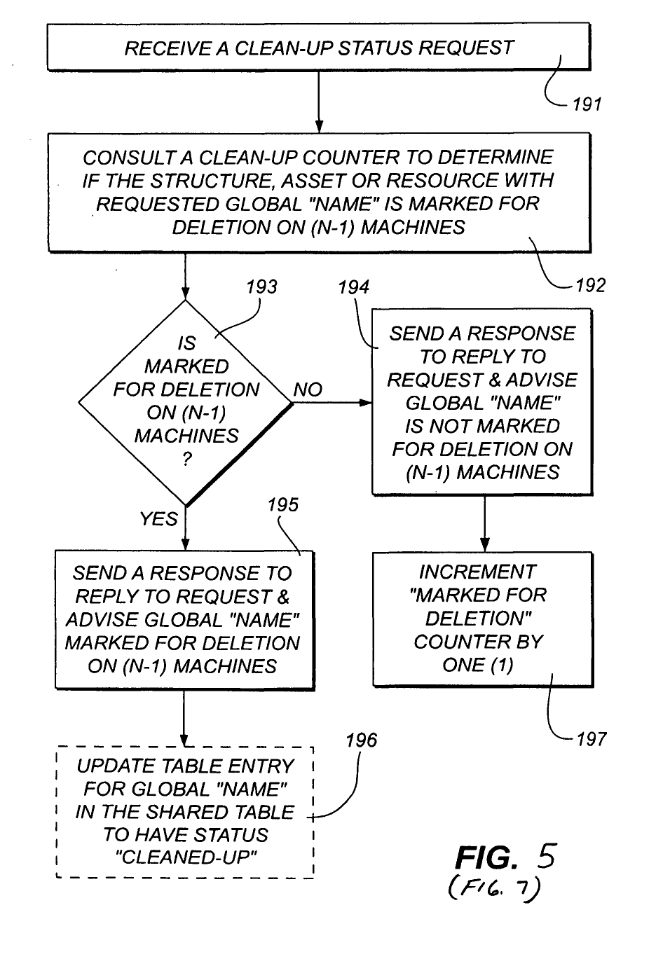

FIG. 5 shows the activity carried out by machine X in response to such a finalization or clean up status enquiry of step 181 in FIG. 4. The finalization or clean up status is determined as seen in step 192 which determines if the replicated application memory object (or location, or content, or value, or class or other asset) corresponding to the clean-up status request of identified (via the global name) replicated application memory object, as received at step 191, is marked for deletion (or alternatively, is unused, or unutilized, or unreferenced) on all other machines other than the enquiring machine 181 from which the clean-up status request of step 191 originates. If the step 193 determination is made that determines that the corresponding replica application memory objects of other machines are not marked (“No”) for deletion (i.e. one or more corresponding replica application memory objects are utilized or referenced elsewhere), then a response to that effect is sent to the enquiring machine 194, and the “marked for deletion” counter is incremented by one (1), as shown by step 197. Similarly, if the answer to this determination is the opposite (“Yes”) indicating that all replica application memory objects of all other machines are marked for deletion (i.e. none of the corresponding replica application memory objects is utilised, or used, or referenced elsewhere), then a corresponding reply is sent to the waiting enquiring machine 182 from which the clean-up status request of step 191 originated as indicated by step 195. The waiting enquiring machine 182 is then able to respond accordingly, such as for example by: (i) aborting (or pausing, or postponing) execution of the application finalization routine when the reply from machine X of step 182 indicated that the one or more corresponding replica application memory objects of one or more other machines are still utilized or used or referenced elsewhere (i.e., not marked for deletion on all other machines other than the machine proposing to carry out finalization); or (ii) by continuing (or resuming, or starting) execution of the application finalization routine when the reply from machine X of step 182 indicated that all corresponding replica application memory objects of all other machines are not utilized or used or referenced elsewhere (i.e., marked for deletion on all other machines other than the machine proposing to carry out finalization).

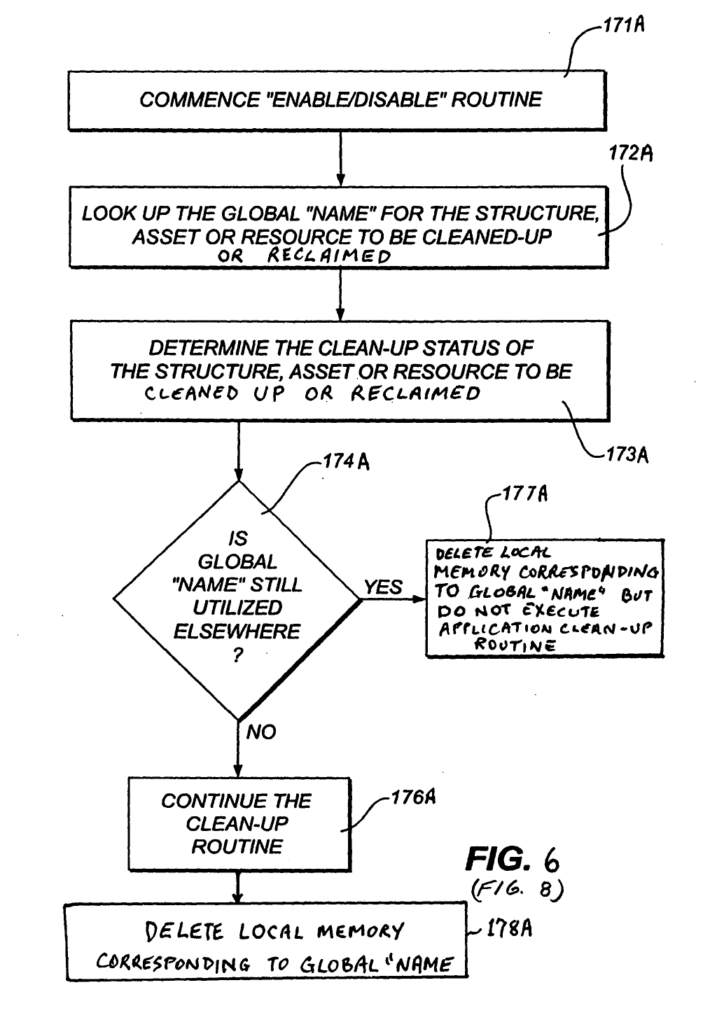

FIG. 6 of the present specification shows the modifications required to FIG. 17 of WO 2005/103 927 (corresponding to FIG. 3 of the present application) required to implement the preferred embodiment of the present invention. Most notably, the step 177A of FIG. 6, replaces the original step 175 of FIG. 3. Regarding FIG. 6, the first three steps, namely steps 171A, 172A, and 173A, remain the same as in FIG. 3, as does step 174A. These four steps, correspond to the determination by one of the plurality of the machines M1 . . . Mn of FIG. 1 that a given replica application memory location/content (or object, class, asset, resource etc), such as replica application memory location/content Z, is able to be deleted.

Starting with step 171A which represents the commencement of the application clean up routine (or application finalization routine or the like), or more generally the determination by a given machine (such as for example machine M3) that replica application memory location/content Z is no longer needed, the steps 172A and 173A, determine the global name or global identity for this replica application memory location/content Z, and determine whether or not one or more other machines of the plurality of machines M1, M2. M4 . . . Mn on which corresponding replica application memory locations/contents reside, continues to use or refer-to their corresponding replica application memory location/content Z.

At step 174A, the determination of whether corresponding replica application memory locations/contents of other machines (e.g. machines M1, M2, M4 . . . Mn) is still utilised (or used or referenced) elsewhere is made and corresponding to a “yes” determination, step 177A takes place. Alternatively, if a determination is made at step 174A the no other machines (e.g. machines M1, M2, M4 . . . Mn) on which corresponding replica application memory locations/contents reside use, utilise, or refer-to their corresponding replica application memory locations/contents, then step 176A and step 178A take place as indicated.

Briefly, at step 176A, the associated application finalization routine (or other associated application cleanup routine or the like) is executed to perform application “clean-up” corresponding to each associated replica application memory locations/contents of all machines no longer being used, utilised, or referenced by each machine. Preferably after execution of such application finalization routine (or the like) of step 176A, step 178A takes place. Alternatively, step 178A may precede step 176A. At step 178A the local memory capacity/storage occupied by the replica application memory object (or class, or memory location(s), or memory content, or memory value(s), or other memory data) is deleted or “freed” or reclaimed, thereby making the local memory capacity/storage previous occupied by the replica application memory location/content available for other data or memory storage needs.

At step 177A, a computing system or run time system implementing the preferred embodiment can proceed to delete (or other wise “free” or reclaim) the local memory space/capacity presently occupied by the local replica application memory location/content Z, whilst not executing the associated application clean up routine or method (or other associated application finalization routine or the like) of step 176A. Importantly, unlike step 175 of FIG. 3, the memory deletion or reclamation or “freeing up” operation to “free” or reclaim the local memory capacity/storage occupied by the local replica application memory location/content is not caused to not be executed (such as for example, aborting execution of such deletion or reclamation of “freeing up” operation) such that the local memory space/storage presently occupied by the local replica application memory location/content Z continues to occupy memory. Instead the local memory space/storage presently occupied by the local replica application memory location/content Z, can be deleted or reclaimed or freed so that it may be used for new application memory contents and/or new application memory locations (or alternatively, no non-application memory contents and/or new non-application memory locations). Importantly however, the associated application clean up routine (or other associated application finalization routine or the like) corresponding to (or associated with) the replica application memory location/content Z, is not to be executed during the deletion or reclamation or “freeing up” of the local memory space/storage occupied by the local replica application memory location/content Z, as this would perform application finalisation and application clean up on behalf of all corresponding replica application memory locations/contents of the plurality of machines.

Preferably, corresponding to step 177A the associated application cleanup routine (or other associated application finalization routine or the like) is not executed, or does not begin execution, or is stopped from initiating or beginning execution. However, in some implementations it is difficult or practically impossible to stop the associated application clean up or finalization routine from initiating or beginning execution. Therefore, in an alternative embodiment, the execution of the associated application finalization routine that has already started is aborted such that it does not complete or does not complete in its normal manner. This alternative abortion is understood to include an actual abortion, or a suspend, or postpone, or pause of the execution of the associated application finalization routine that has started to execute (regardless of the stage of execution before completion) and therefore to make sure that the associated application finalization routine does not get the chance to execute to completion to clean up the replicated application memory location/content to which the application finalization routine is associated.

The improvement that this method represents over the previous prior art is that the local memory space/storage/capacity previously occupied by the replica application memory location/content Z is deleted or reclaimed or freed to be used for other useful work (such as storing other application memory locations/contents, or alternatively storing other non-application memory locations/contents), even though one of more other machines continue to use or utilise or refer-to their local corresponding replica application memory location/content Z. Thus, instead of utilizing a general or regular application memory clean-up routine (or other application finalization routine or the like) to delete or reclaim or free the local memory capacity/storage associated with the local replica application memory location/content, a non-application memory deletion action (177A) is provided and used to directly reclaim the memory without execution of the associated application clean-up routine or finalization routine or the like. Thus memory deletion or reclamation, instead of being carried out at a deferred time when all corresponding replica application memory locations/contents of all machines are no longer used, utilised, or referenced, is instead carried out “silently” (that is, unknown to the application program) by each machine independently of any other machine.

Thus, is accordance with one embodiment, the application finalization routine (or the like) is aborted, discontinued, or otherwise not caused to be executed upon occasion of step 177A is to take place. Thus, this preferably takes the form of disabling the execution of the application finalization or other cleanup routine or operations. However, the runtime system, software platform, operating system, garbage collector, other application runtime support system or the like is allowed to deleted, free, reclaim, recover, clear, or deallocate the local memory capacity/space utilised by the local replica application memory object, thus making such local memory capacity/space available for other data or memory storage needs. Thus, unlike the prior art where the deletion of the application memory and the execution of the application finalization routine was postponed until all machines similarly wished to delete or reclaim their local corresponding replica application memory objects, in accordance with the present invention replica application memory objects are free to be deleted, reclaimed, recovered, revoked, deallocated or the like, without a corresponding execution of the application finalization (or the like) routine, and independently of any other machine. As a result, replica application memory objects may be “safely” deleted, garbage collected, removed, revoked, deallocated etc without causing or resulting in inconsistent operation of the remaining corresponding replica application memory objects on other machines.

Importantly then, when a replica application memory object is to be deleted but the associated application finalization routine is not executed (such as in accordance with step 177A), then preferably such deletion (or other memory freeing operation) comprises or includes deleting or freeing the local memory space/storage occupied by the replica application memory object, but not signalling to the application program that such deletion has occurred by means of executing an application finalization routine or similar. Thus, the application program is left unaware that the replica application memory object has been deleted (or reclaimed, or freed etc), and the application program and the remaining corresponding replica application memory objects of other machines continue to operate in a normal fashion without knowledge or awareness that one or more corresponding replica application memory objects have been deleted.

The use of the terms “application finalization routine” or “application cleanup routine” or the like herein are to be understood to also include within their scope any automated application memory reclamation methods (such as may be associated with garbage collectors and the like), as well as any non-automated application memory reclamation methods. ‘Non-automated application memory reclamation methods' (or functions, or procedures, or routines, or operations or the like) may include any ‘non-garbage collected’ application memory reclamation methods (or functions, or routines, or operations, or procedures, etc), such as manual or programmer-directed or programmer-implemented application memory reclamation methods or operations or functions, such as for example those known in the prior art and associated with the programming languages of C, C++, FORTRAN, COBOL, and machine-code languages such as x86, SPARC, PowerPC, or intermediate-code languages). For example, in the C programming language, the “free( )” function may be used by the application program/application programmer to free memory contents/data previously allocated via the “malloc( )” function, when such application memory contents are no longer required by the application program.

Further, the use of the term “memory deletion” (such as for example step 177A of FIG. 6) and the like used herein, are to be understood to include within their scope any “memory freeing” actions or operations resulting in the deletion or freeing of the local memory capacity/storage occupied by a replica application memory object (or class, or memory location(s), or memory content, or memory value(s), or other memory data), independent of execution of any associated application finalization routines or the like.

In alternative computing platforms, application programs, software systems, or other hardware and/or software computing systems generally, more than one application finalization routine or application cleanup routine or the like may be associated with a replicated application memory location/content. Though the above description is described with reference to a single application finalization routine or the like associated with a replicated application memory location/content, the methods of this invention apply mutatis mutandis to circumstances where there are multiple application finalization routines or the like associated with a replicated application memory location/content. Specifically, when multiple application finalization routines or the like are associated with a replicated application memory location/content, then step 177A is to be understood to apply to all such multiple associated application finalization routines or the like. Preferably also, when multiple application finalization routines or the like are associated with a replicated application memory location/content, then step 176A is to be understood to also apply to all such multiple application finalization routines or the like.

To summarize, there is disclosed a method of running simultaneously on a plurality of computers at least one application program each written to operate only on a single computer, the computers being interconnected by means of a communications network, the method comprising the steps of:
(i) executing different portions of the application program(s) on different ones of the computers and for at least some of the computers creating a like plurality of substantially identical objects each in the corresponding computer and each having a substantially identical name, and
(ii) permitting each computer to delete its currently unused local memory corresponding to a replicated object and without initiating a general clean-up routine, notwithstanding that other one(s) of the computers are currently using their corresponding local memory.

Preferably the method includes the further step of:
(iii) utilizing a global name for all corresponding replicated memory objects.

Preferably the method includes the further step of:
(iv) before carrying out step (ii) using the global name to ascertain whether the unused local memory replica is in use elsewhere and if not, initiating the general clean-up routine.

There is also disclosed a multiple computer system having at least one application program each written to operate only on a single computer but running simultaneously on a plurality of computers interconnected by a communications network, wherein different portions of the application program(s) execute substantially simultaneously on different ones of the computers and for at least some of the computers a like plurality of substantially identical objects are replicated, each in the corresponding computer, and wherein each computer can delete its currently local unused memory corresponding to a replicated object and without initiating a general clean-up routine, notwithstanding that other one(s) of the computers are currently using their corresponding local memory.

Preferably a global name is used for all corresponding replicated memory objects.

Preferably the global name is used to ascertain whether the unused local memory replica is in use elsewhere before carrying out a local deletion, and if not in use elsewhere the general clean-up routine is initiated.

In addition, there is disclosed a single computer adapted to form part of a multiple computer system, the single computer having an independent local memory and a data port by means of which the single computer can communicate with a communications network of the multiple computer system to send and receive data to update at least one application memory location which is located in the independent local memory and replicated in the independent local memory of at least one other computer of the multiple computer system to enable different portions of the same application program to execute substantially simultaneously on different computers of the multiple computer system, and wherein the single computer can delete its local currently unused memory corresponding to a replicated application location and without initializing or executing an associated application clean-up routine, notwithstanding that other one(s) of the computers are currently using their corresponding local memory.

In addition, there is also disclosed a computer program product which when loaded into a computer enables the computer to carry out the above method.

The foregoing describes only one embodiment of the present invention and modifications, obvious to those skilled in the computing arts, can be made thereto without departing from the scope of the present invention.

The terms “executable code”, “object-code”, “code-sequence”, “instruction sequence”, “operation sequence”, and other such similar terms used herein are to be understood to include any sequence of two or more codes, instructions, operations, or similar. Importantly, such terms are not to be restricted to formal bodies of associated code or instructions or operations, such as methods, procedures, functions, routines, subroutines or similar, and instead such terms above may include within their scope any subset or excerpt or other partial arrangement of such formal bodies of associated code or instructions or operations, Alternatively, the above terms may also include or encompass the entirety of such formal bodies of associated code or instructions or operations.

Lastly, it will also be known to those skilled in the computing arts that when searching the executable code to detect write operations, other operations, or more generally any other instructions or operations, that it may be necessary not to search through the code in the order that it is stored in its compiled form, but rather to search through the code in accordance with various alternative control flow paths such as conditional and unconditional branches. Therefore in the determination that one operation precedes another, it is to be understood that the two operations may not appear chronologically or sequentially in the compiled object code, but rather that a first operation may appear later in the compiled code representation than a second operation but when such code is executed in accordance with the control-flow paths contained therein, the “first” operation will take place or precede the execution of the “second” operation.

At step 164 the loading procedure of the software platform, computer system or language is continued, resumed or commenced with the understanding that the loading procedure continued, commenced, or resumed at step 164 does so utilising the modified executable object code that has been modified in accordance with the steps of this invention and not the original unmodified application executable object code originally with which the loading procedure commenced at step 161.

The term “distributed runtime system”, “distributed runtime”, or “DRT” and such similar terms used herein are intended to capture or include within their scope any application support system (potentially of hardware, or firmware, or software, or combination and potentially comprising code, or data, or operations or combination) to facilitate, enable, and/or otherwise support the operation of an application program written for a single machine (e.g. written for a single logical shared-memory machine) to instead operate on a multiple computer system with independent local memories and operating in a replicated shared memory arrangement. Such DRT or other “application support software” may take many forms, including being either partially or completely implemented in hardware, firmware, software, or various combinations therein.

The methods of this invention described herein are preferably implemented in such an application support system, such as DRT described in International Patent Application No. PCT/AU2005/000580 published under WO 2005/103926 (and to which U.S. patent application Ser. No. 11/111,946 Attorney Code 5027F-US corresponds), however this is not a requirement of this invention. Alternatively, an implementation of the methods of this invention may comprise a functional or effective application support system (such as a DRT described in the above-mentioned PCT specification) either in isolation, or in combination with other softwares, hardwares, firmwares, or other methods of any of the above incorporated specifications, or combinations therein.

The reader is directed to the abovementioned PCT specification for a full description, explanation and examples of a distributed runtime system (DRT) generally, and more specifically a distributed runtime system for the modification of application program code suitable for operation on a multiple computer system with independent local memories functioning as a replicated shared memory arrangement, and the subsequent operation of such modified application program code on such multiple computer system with independent local memories operating as a replicated shared memory arrangement.

Also, the reader is directed to the abovementioned PCT specification for further explanation, examples, and description of various methods and means which may be used to modify application program code during loading or at other times.

Also, the reader is directed to the abovementioned PCT specification for further explanation, examples, and description of various methods and means which may be used to modify application program code suitable for operation on a multiple computer system with independent local memories and operating as a replicated shared memory arrangement.

Finally, the reader is directed to the abovementioned PCT specification for further explanation, examples, and description of various methods and means which may be used to operate replicated memories of a replicated shared memory arrangement, such as updating of replicated memories when one of such replicated memories is written-to or modified.

Furthermore, it will be appreciated by those skilled in the computing arts that the act of inserting instructions into a compiled object code sequence (or other code or instruction or operation sequence) may need to take into account various instruction and code offsets that are used in or by the object code or other code-sequence and that will or may be altered by the insertion of new instructions into the object code or other code-sequence. For example, it may be necessary in the instance where instructions or operations are inserted at a point corresponding to some other instruction(s) or operation(s), that any branches, paths, jumps, or branch offsets or similar that span the location(s) of the inserted instructions or operations may need to be updated to account for these additionally inserted instructions or operations.

Such processes of realigning branch offsets, attribute offsets or other code offsets, pointers or values (whether within the code, or external to the code or instruction sequence but which refer to specific instructions or operations contained within such code or instruction sequence) may be required or desirable of an implementation or embodiment of this invention, and such requirements will be known to those skilled in the computing arts and able to be realized by such persons skilled in the computing arts.

In alternative multicomputer arrangements, such as distributed shared memory arrangements and more general distributed computing arrangements, the above described methods may still be applicable, advantageous, and used. Specifically, any multi-computer arrangement where replica, “replica-like”, duplicate, mirror, cached or copied memory locations exist, such as any multiple computer arrangement where memory locations (singular or plural), objects, classes, libraries, packages etc are resident on a plurality of connected machines and preferably updated to remain consistent, then the methods apply. For example, distributed computing arrangements of a plurality of machines (such as distributed shared memory arrangements) with cached memory locations resident on two or more machines and optionally updated to remain consistent comprise a functional “replicated memory system” with regard to such cached memory locations, and is to be included within the scope of the present invention. Thus, it is to be understood that the aforementioned methods apply to such alternative multiple computer arrangements. The above disclosed methods may be applied in such “functional replicated memory systems” (such as distributed shared memory systems with caches) mutatis mutandis.

It is also provided and envisaged that any of the described functions or operations described as being performed by an optional server machine X (or multiple optional server machines) may instead be performed by any one or more than one of the other participating machines of the plurality (such as machines M1, M2, M3 . . . Mn of FIG. 1).

Alternatively or in combination, it is also further provided and envisaged that any of the described functions or operations described as being performed by an optional server machine X (or multiple optional server machines) may instead be partially performed by (for example broken up amongst) any one or more of the other participating machines of the plurality, such that the plurality of machines taken together accomplish the described functions or operations described as being performed by an optional machine X. For example, the described functions or operations described as being performed by an optional server machine X may broken up amongst one or more of the participating machines of the plurality.

Further alternatively or in combination, it is also further provided and envisaged that any of the described functions or operations described as being performed by an optional server machine X (or multiple optional server machines) may instead be performed or accomplished by a combination of an optional server machine X (or multiple optional server machines) and any one or more of the other participating machines of the plurality (such as machines M1, M2, M3 . . . Mn), such that the plurality of machines and optional server machines taken together accomplish the described functions or operations described as being performed by an optional single machine X. For example, the described functions or operations described as being performed by an optional server machine X may broken up amongst one or more of an optional server machine X and one or more of the participating machines of the plurality.

The terms “object” and “class” used herein are derived from the JAVA environment and are intended to embrace similar terms derived from different environments, such as modules, components, packages, struts, libraries, and the like.

The use of the term “object” and “class” used herein is intended to embrace any association of one or more memory locations. Specifically for example, the term “object” and “class” is intended to include within its scope any association of plural memory locations, such as a related set of memory locations (such as, one or more memory locations comprising an array data structure, one or more memory locations comprising a strut, one or more memory locations comprising a related set of variables, or the like).

Reference to JAVA in the above description and drawings. includes, together or independently, the JAVA language, the JAVA platform, the JAVA architecture, and the JAVA virtual machine. Additionally, the present invention is equally applicable mutatis mutandis to other non-JAVA computer languages (including for example, but not limited to any one or more of, programming languages, source-code languages, intermediate-code languages, object-code languages, machine-code languages, assembly-code languages, or any other code languages), machines (including for example, but not limited to any one or more of, virtual machines, abstract machines, real machines, and the like), computer architectures (including for example, but not limited to any one or more of, real computer/machine architectures, or virtual computer/machine architectures, or abstract computer/machine architectures, or microarchitectures, or instruction set architectures, or the like), or platforms (including for example, but not limited to any one or more of, computer/computing platforms, or operating systems, or programming languages, or runtime libraries, or the like).

Examples of such programming languages include procedural programming languages, or declarative programming languages, or object-oriented programming languages. Further examples of such programming languages include the Microsoft.NET language(s) (such as Visual BASIC, Visual BASIC.NET, Visual C/C++, Visual C/C++.NET, C#, C#.NET, etc), FORTRAN, C/C++, Objective C, COBOL, BASIC, Ruby, Python, etc.

Examples of such machines include the JAVA Virtual Machine, the Microsoft .NET CLR, virtual machine monitors, hypervisors, VMWare, Xen, and the like.

Examples of such computer architectures include, Intel Corporation's x86 computer architecture and instruction set architecture, Intel Corporation's NetBurst microarchitecture, Intel Corporation's Core microarchitecture, Sun Microsystems' SPARC computer architecture and instruction set architecture, Sun Microsystems' UltraSPARC III microarchitecture, IBM Corporation's POWER computer architecture and instruction set architecture, IBM Corporation's POWER4/POWER5/POWER6 microarchitecture, and the like.

Examples of such platforms include, Microsoft's Windows XP operating system and software platform, Microsoft's Windows Vista operating system and software platform, the Linux operating system and software platform, Sun Microsystems' Solaris operating system and software platform, IBM Corporation's AIX operating system and software platform, Sun Microsystems' JAVA platform, Microsoft's .NET platform, and the like.

When implemented in a non-JAVA language or application code environment, the generalized platform, and/or virtual machine and/or machine and/or runtime system is able to operate application code 50 in the language(s) (including for example, but not limited to any one or more of source-code languages, intermediate-code languages, object-code languages, machine-code languages, and any other code languages) of that platform, and/or virtual machine and/or machine and/or runtime system environment, and utilize the platform, and/or virtual machine and/or machine and/or runtime system and/or language architecture irrespective of the machine manufacturer and the internal details of the machine. It will also be appreciated in light of the description provided herein that platform and/or runtime system may include virtual machine and non-virtual machine software and/or firmware architectures, as well as hardware and direct hardware coded applications and implementations.

For a more general set of virtual machine or abstract machine environments, and for current and future computers and/or computing machines and/or information appliances or processing systems, and that may not utilize or require utilization of either classes and/or objects, the inventive structure, method, and computer program and computer program product are still applicable. Examples of computers and/or computing machines that do not utilize either classes and/or objects include for example, the x86 computer architecture manufactured by Intel Corporation and others, the SPARC computer architecture manufactured by Sun Microsystems, Inc and others, the PowerPC computer architecture manufactured by International Business Machines Corporation and others, and the personal computer products made by Apple Computer, Inc., and others. For these types of computers, computing machines, information appliances, and the virtual machine or virtual computing environments implemented thereon that do not utilize the idea of classes or objects, may be generalized for example to include primitive data types (such as integer data types, floating point data types, long data types, double data types, string data types, character data types and Boolean data types), structured data types (such as arrays and records) derived types, or other code or data structures of procedural languages or other languages and environments such as functions, pointers, components, modules, structures, references and unions.

In the JAVA language memory locations include, for example, both fields and elements of array data structures. The above description deals with fields and the changes required for array data structures are essentially the same mutatis mutandis.

Any and all embodiments of the present invention are able to take numerous forms and implementations, including in software implementations, hardware implementations, silicon implementations, firmware implementation, or software/hardware/silicon/firmware combination implementations.

Various methods and/or means are described relative to embodiments of the present invention. In at least one embodiment of the invention, any one or each of these various means may be implemented by computer program code statements or instructions (possibly including by a plurality of computer program code statements or instructions) that execute within computer logic circuits, processors, ASICs, microprocessors, microcontrollers, or other logic to modify the operation of such logic or circuits to accomplish the recited operation or function. In another embodiment, any one or each of these various means may be implemented in firmware and in other embodiments may be implemented in hardware. Furthermore, in at least one embodiment of the invention, any one or each of these various means may be implemented by a combination of computer program software, firmware, and/or hardware.

Any and each of the aforedescribed methods, procedures, and/or routines may advantageously be implemented as a computer program and/or computer program product stored on any tangible media or existing in electronic, signal, or digital form. Such computer program or computer program products comprising instructions separately and/or organized as modules, programs, subroutines, or in any other way for execution in processing logic such as in a processor or microprocessor of a computer, computing machine, or information appliance; the computer program or computer program products modifying the operation of the computer on which it executes or on a computer coupled with, connected to, or otherwise in signal communications with the computer on which the computer program or computer program product is present or executing. Such computer program or computer program product modifying the operation and architectural structure of the computer, computing machine, and/or information appliance to alter the technical operation of the computer and realize the technical effects described herein.

For ease of description, some or all of the indicated memory locations herein may be indicated or described to be replicated on each machine (as shown in FIG. 1A), and therefore, replica memory updates to any of the replicated memory locations by one machine, will be transmitted/sent to all other machines. Importantly, the methods and embodiments of this invention are not restricted to wholly replicated memory arrangements, but are applicable to and operable for partially replicated shared memory arrangements mutatis mutandis (e.g. where one or more memory locations are only replicated on a subset of a plurality of machines, such as shown in FIG. 1B).

The term “comprising” (and its grammatical variations) as used herein is used in the inclusive sense of “including” or “having” and not in the exclusive sense of “consisting only of”.

I/We claim:

1. A method of running simultaneously on a multiple computer system including a plurality of computers at least one application program, the or each of the at least one application program written to operate only on a single computer, said plurality of computers being interconnected by means of a communications network, said method of running said at least one application program simultaneously on said plurality of computers comprising:
(i) executing different portions of said application program(s) on different ones of said plurality of computers and for at least some of the said plurality of computers creating a like plurality of substantially identical replicated objects each in the corresponding computer and each having a substantially identical name; and
(ii) permitting each computer of said plurality of computers to delete its currently unused local memory corresponding to a replicated object and without initiating a general clean-up routine, notwithstanding that other one(s) of said plurality of computers are currently using their corresponding local memory.

2. A computer program stored in a computer readable media, the computer program including executable computer program instructions and adapted for execution by a plurality of computers in a multiple computer system including a plurality of computers to modify the operation of the multiple computer system; the modification of operation including performing a method of running said at least one application program simultaneously on said plurality of computers, said method comprising:
(i) executing different portions of said application program(s) on different ones of said plurality of computers and for at least some of the said plurality of computers creating a like plurality of substantially identical replicated objects each in the corresponding computer and each having a substantially identical name; and
(ii) permitting each computer of said plurality of computers to delete its currently unused local memory corresponding to a replicated object and without initiating a general clean-up routine, notwithstanding that other one(s) of said plurality of computers are currently using their corresponding local memory.

3. A multiple computer system comprising:
a plurality of local computers interconnected by an external communications network, said plurality of local computers adapted for substantially simultaneous executing of different portions of least one application program each written to operate only on a single local computer, and for at least some of the said plurality of computers a like plurality of substantially identical objects are replicated, each of the substantially identical objects being replicated in a corresponding one of said plurality of computers;
each of said plurality of local computers further including:
a local processor executing instructions of at least a portion of at least one application program, and a local memory coupled to said local processor; and
means for deleting said local computer's currently unused local memory corresponding to a replicated object within said multiple computer system, said deleting being performed without initiating a general memory clean-up routine and notwithstanding that other one(s) of said plurality of local computers are or may be currently using their own corresponding local memory.

4. A multiple computer system as defined in claim 3, wherein the multiple computer system further comprises the external communications network.
